(19) United States
(12) Patent Application Publication
(10) Pub. No.: US 2025/0365284 A1
(43) Pub. Date: Nov. 27, 2025

(54) AUTHORIZATION DEVICE, AUTHORIZATION METHOD, AND NON-TRANSITORY COMPUTER READABLE MEDIUM

(71) Applicant: Mitsubishi Electric Corporation, Tokyo (JP)

(72) Inventor: Takumi MORI, Tokyo (JP)

(73) Assignee: Mitsubishi Electric Corporation, Tokyo (JP)

(21) Appl. No.: 19/297,601

(22) Filed: Aug. 12, 2025

Related U.S. Application Data
(63) Continuation of application No. PCT/JP2023/014627, filed on Apr. 10, 2023.

(51) Int. Cl. H04L 9/40

(52) U.S. Cl. CPC H04L 63/10; H04L 63/1433

(57) ABSTRACT

An authorization device (100) includes a valid condition assessment unit (180) that assesses whether a valid condition is met so as to judge whether an authorization rule is valid or not. The valid condition is a condition which is generated on a basis of a countermeasure scenario to address a vulnerability related to access to a target system storing an electronic file, and which concerns an authorization target requiring authorization for access to the target system. The authorization rule is a rule for the valid condition and authorizes access to the target system.

### CROSS REFERENCE TO RELATED APPLICATION

This application is a Continuation of PCT International Application No. PCT/JP2023/014627, filed on Apr. 10, 2023, which is hereby expressly incorporated by reference into the present application.

### TECHNICAL FIELD

The present disclosure relates to an authorization device, an authorization method, and an authorization program.

### BACKGROUND ART

There exists a technology that analyzes the risk of a system using information related to the system's vulnerabilities.

Patent Literature 1 discloses a technique that models vulnerabilities (MITRE CWE (Registered Trademark, Common Weakness Enumeration)) of an attacked system by utilizing system specifications of the target system, so as to generate vulnerability model information that includes a successful attack condition or an attack result, etc. The technique then analyzes threats in the target system using the generated vulnerability model information.

### CITATION LIST

### Patent Literature

Patent Literature 1: WO 2019/093059

### SUMMARY OF INVENTION

### Technical Problem

Vulnerabilities related to access to a system are updated in accordance with advancements in technology, etc. Therefore, it is desirable to judge whether an authorization rule, which is a rule that authorizes access from an authorization target to a target system is valid or not, using a valid condition that dynamically changes in accordance with update of vulnerabilities related to access to the system.

However, according to Patent Literature 1, there is a problem that it is impossible to judge whether the authorization rule is valid or not using a condition that dynamically changes in accordance with update of vulnerabilities related to access to the system, because whether the authorization rule is valid or not is not judged using a valid condition.

The present disclosure aims to judge whether an authorization rule is valid or not using a condition that dynamically changes in accordance with update of vulnerabilities related to access to a system.

### Solution to Problem

An authorization device according to the present disclosure includes
a valid condition assessment unit to assess whether a valid condition is met so as to judge whether an authorization rule is valid, the valid condition being a condition which is generated on a basis of a countermeasure scenario to address vulnerabilities related to access to a target system storing an electronic file, and which concerns an authorization target requiring authorization of access to the target system, the authorization rule being a rule for the valid condition and authorizing access to the target system.

### Advantageous Effects of Invention

According to this disclosure, a valid condition assessment unit assesses whether a valid condition is met so as to judge whether an authorization rule is valid. Here, the valid condition is a condition generated on a basis of a countermeasure scenario to address vulnerabilities related to access to a target system. Therefore, the valid condition may be dynamically changed in accordance with update of the vulnerabilities related to access to the system. Thus, according to this disclosure, it is possible to judge whether an authorization rule is valid or not using the condition that dynamically changes in accordance with update of vulnerabilities related to access to the system.

### BRIEF DESCRIPTION OF DRAWINGS

FIG. 1 is a diagram showing a configuration example of an authorization system 90 according to Embodiment 1.

FIG. 2 is a diagram showing a hardware configuration example of an authorization device 100 according to Embodiment 1.

FIG. 3 is a flowchart illustrating a risk definition flow according to Embodiment 1.

FIG. 4 is a diagram describing the risk definition flow according to Embodiment 1.

FIG. 5 is a flowchart illustrating a valid condition judgment flow according to Embodiment 1.

FIG. 6 is a diagram describing the valid condition judgment flow according to Embodiment 1.

FIG. 7 is a diagram showing a hardware configuration example of the authorization device 100 according to a modification of Embodiment 1.

FIG. 8 is a flowchart showing a risk definition flow according to Embodiment 2.

FIG. 9 is a diagram describing the risk definition flow according to Embodiment 2.

FIG. 10 is a flowchart illustrating a valid condition judgment flow according to Embodiment 2.

FIG. 11 is a diagram describing the valid condition judgment flow according to Embodiment 2.

### DESCRIPTION OF EMBODIMENTS

In the description and drawings of the embodiments, the same reference numerals are assigned to the same elements and equivalent elements. The explanation of elements with the same reference signs may be appropriately omitted or simplified. Arrows in diagrams primarily indicate data flows or processing flows. Additionally, the term “unit” may appropriately be replaced with “circuit”, “stage”, “procedure”, “process”, or “circuitry”.

### Embodiment 1

Hereinafter, the present Embodiment will be described in detail with reference to the drawings.

In dynamic authorization, the reliability of an authorization rule may decrease over time. Therefore, it is necessary to keep the authorization rule updated in line with the risk assessment about cyber attacks in the world in order to prevent the reliability of the authorization rule from declining. Thus, the purpose of this Embodiment is to maintain or enhance the reliability of the authorization rule by taking into account the security risks and vulnerabilities recognized in the world.

### ***Description of Configuration***

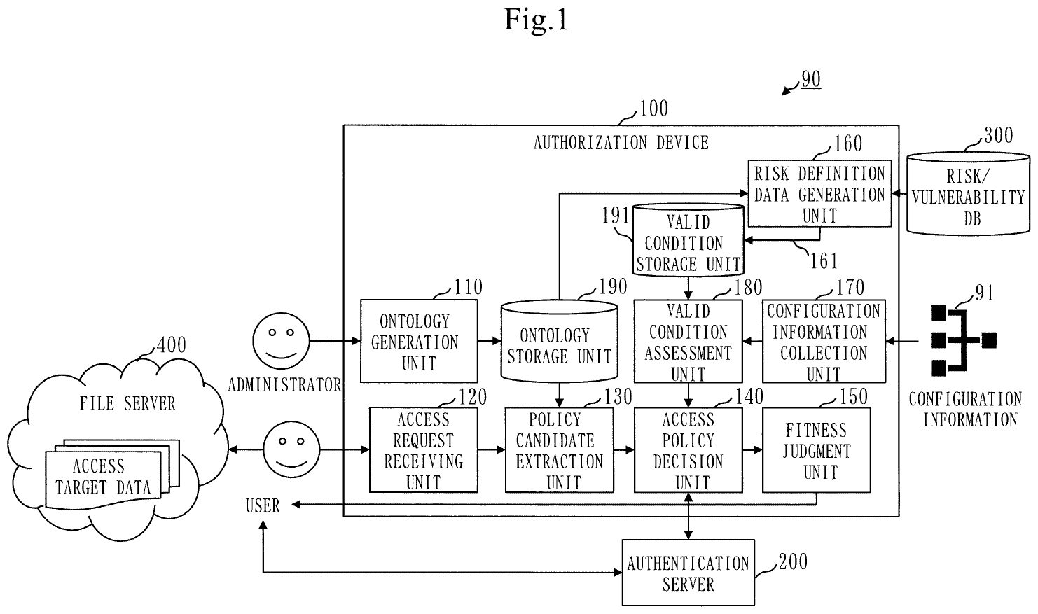

FIG. 1 shows a configuration example of an authorization system 90 according to this Embodiment. The authorization system 90, as shown in FIG. 1, includes an authorization device 100, an authentication server 200, a risk/vulnerability DB (Database) 300, and a file server 400. The authorization device 100 is also called an authorization server. The multiple components provided to the authorization system 90 may be suitably integrated.

A user accesses the file server 400 from a user system.

Configuration information 91 is information indicating a configuration of the user system. Specifically, for example, the configuration information 91 includes information indicating, among others, a network configuration of the user system, security features possessed and a communication protocol used by each PC (Personal Computer), each server, and various devices provided to the user system.

It is assumed that the authorization device 100 is capable of acquiring the configuration information 91.

The authorization device 100 comprises an ontology generation unit 110, an access request receiving unit 120, a policy candidate extraction unit 130, an access policy decision unit 140, a fitness judgment unit 150, a risk definition data generation unit 160, a configuration information collection unit 170, a valid condition assessment unit 180, an ontology storage unit 190, and a valid condition storage unit 191.

Please note that the authorization device 100 is an extension from the access judgment device mentioned in [Reference 1]. The ontology generation unit 110, the access request receiving unit 120, the policy candidate extraction unit 130, the fitness judgment unit 150, and the ontology storage unit 190 are as described in [Reference 1]. In addition, the access policy decision unit 140 is similar to the access rule decision unit in [Reference 1].

Below, the differences between the access judgment device in [Reference 1] and the authorization device 100 will be described.

### Reference 1

WO 2022/149226

The risk definition data generation unit 160 acquires risk information and information indicating a successful attack condition from the risk/vulnerability DB 300. The risk definition data generation unit 160 generates risk definition data 161 which includes a valid condition, based on the acquired information, and stores the generated risk definition data 161 to the valid condition storage unit 191.

The risk information refers to information indicating content of risk in the file server 400.

The successful attack condition refers to a condition under which a cybersecurity attack on the file server 400 is executed successfully.

The valid condition storage unit 191 stores the risk definition data 161 generated by the risk definition data generation unit 160. Additionally, the valid condition storage unit 191 provides the stored risk definition data 161 to the valid condition assessment unit 180 when the valid condition assessment unit 180 assesses the valid condition.

The risk definition data 161 is data indicating a content of the risk, a countermeasure scenario, the valid condition, and authorization rule ID (Identification). Data indicating the content of the risk and data indicating the valid condition are metadata for each authorization rule. The risk definition data 161 is data that correlates the data indicating the valid condition and the data indicating a content of a risk to the valid condition.

The content of the risk is utilized by the administrator or the like of the file server 400 for managing the valid condition. For example, the content of the risk is used when the administrator checks whether the valid condition is appropriate.

The countermeasure scenario is a scenario that denies the successful attack condition, corresponds to a method to offset the successful attack condition, and addresses vulnerabilities related to access to the target system.

The valid condition is a condition generated on a basis of the countermeasure scenario and concerning an authorization target requiring authorization of access to the target system. The authorization target is, for example, the entire user system, or part of the user system that the user uses for accessing the file server 400. In addition, the valid condition is a condition that realizes the countermeasure scenario, that inhibits the successful attack condition, that authorizes access to the file server 400, and that is for each authorization rule.

The authorization rule is a rule for access restriction to the file server 400. If a valid condition for a certain authorization rule becomes void, the certain authorization rule may be discarded, or the access for the certain authorization rule may become an access denial target.

The authorization rule ID is an identifier for the authorization rule to which the valid condition is to be applied.

Meanwhile, by linking the risk definition data 161 with the authorization rule in dynamic authorization, a risk that can actually be eliminated can be linked with the authorization rule. By linking the risk with the authorization rule, the administrator or the like of the authorization rule can perceive the importance of the authorization rule.

The configuration information collection unit 170 collects the configuration information 91 from the user system and provides the collected configuration information 91 to the valid condition assessment unit 180.

The valid condition assessment unit 180 assesses whether the valid condition is met so as to judge whether the authorization rule is valid. The authorization rule is a rule for the valid condition and that authorizes access to the target system.

The valid condition assessment unit 180 assesses whether a valid condition is met on a basis of the configuration information 91. The configuration information 91 is information indicating the configuration of the authorization target.

The authentication server 200 is a server that executes authentication processing.

The risk/vulnerability DB 300 is a database storing data related to the vulnerabilities of the system. For instance, the risk/vulnerability DB 300 could be a database that manages security vulnerabilities, such as CVE (registered trademark, Common Vulnerabilities and Exposures) of MITRE corporation, NVD (National Vulnerability Database) of NIST (National Institute of Standards and Technology), a database managed by JPCERT/CC (Japan Computer Emergency Response Team Coordination Center), or JVN iPedia managed by the Information-technology Promotion Agency (IPA). Alternatively, the risk/vulnerability DB 300 could be a knowledge database related to cyber attacks, such as CAPEC (registered trademark, Common Attack Pattern Enumeration and Classification) of MITRE corporation, or ATT&CK (Adversarial Tactics, Techniques & Common Knowledge).

The authorization device 100 is assumed to be able to acquire information indicating security risks, attack scenarios, or successful attack condition, etc., from the risk/vulnerability DB 300.

The file server 400 is a server that stores data being a target of access of the user. The file server 400 is a system protected by the authentication server 200 and the authorization device 100, and is also called a target system. The file server 400 can be a cloud server, or can be an on-premises server.

The target system is a system that stores an electronic file and typically a system that adopts a zero trust model. Specific examples of the zero trust model are described in [Reference 2].

### Reference 2

Kindervag, J., “Build Security Into Your Network's DNA: The Zero Trust Network Architecture”, Forrester Research, 2010

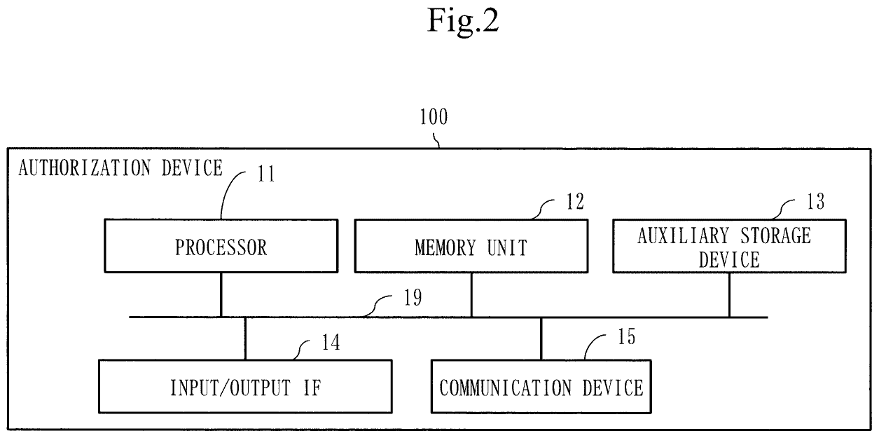

FIG. 2 presents a hardware configuration example of the authorization device 100 according to this Embodiment. The authorization device 100 is comprised of a computer. The authorization device 100 may also be made up of multiple computers.

As shown in this figure, the authorization device 100 is a computer provided with hardware such as a processor 11, a memory unit 12, an auxiliary storage device 13, an input/output IF (Interface) 14, and a communication device 15. These hardware components are appropriately connected via a signal line 19.

The processor 11 is an IC (Integrated Circuit) that performs arithmetic processing, and controls the hardware equipped to the computer. Specific examples of the processor 11 include a CPU (Central Processing Unit), a DSP (Digital Signal Processor), and a GPU (Graphics Processing Unit).

The authorization device 100 may include a plurality of processors as an alternative to the processor 11. These multiple processors share the role of the processor 11.

The memory unit 12 is typically a volatile memory device, for example, a RAM (Random Access Memory). The memory unit 12 is also referred to as the primary memory or the main memory unit. The data stored in the memory unit 12 is saved in the auxiliary storage device 13 as needed.

The auxiliary storage device 13 is typically a non-volatile storage device and for instance, could be a ROM (Read Only Memory), an HDD (Hard Disk Drive), or a flash memory. The data stored in the auxiliary storage device 13 is loaded into the memory unit 12 as needed.

The memory unit 12 and the auxiliary storage device 13 may be configured integrally. The input/output IF 14 is a port where input and output devices are connected. The input/output IF 14 is, as a specific example, a USB (Universal Serial Bus) terminal. The input device is formed of, as a specific example, a keyboard and a mouse. The output device is, for example, a display.

The communication device 15 is a receiver/transmitter. As a specific example, the communication device 15 can be a communication chip or an NIC (Network Interface Card).

Each part of the authorization device 100 may appropriately use the input/output IF 14 and the communication device 15 when communicating with other devices or the like.

The auxiliary storage device 13 stores an authorization program. The authorization program is a program that enables a function of each part of the authorization device 100 to be implemented on the computer. The authorization program is loaded into the memory unit 12 and executed by the processor 11. The function of each part of the authorization device 100 is implemented by software.

Data used to execute the authorization program, data obtained by executing the authorization program, and the like are suitably stored in the storage device. Each part of the authorization device 100 appropriately utilizes the storage device. The storage device, for example, consists of at least one of the memory unit 12, the auxiliary storage device 13, a register in the processor 11, and a cache memory in the processor 11. It should be noted that the term “data” and the term “information” may sometimes have the same meanings. The storage device may be independent of the computer.

The functions of the memory unit 12 and the auxiliary storage device 13 may be implemented by another storage device.

The authorization program may be recorded on a computer readable non-volatile recording medium. As a specific example, the non-volatile recording medium is an optical disc or flash memory. The authorization program may be provided as a program product.

A hardware configuration of any other configuration element that the authorization system 90 possesses may be similar to the hardware configuration of the authorization device 100.

### ***Description of Operation***

An operation procedure of the authorization device 100 corresponds to an authorization method. Also, a program that realizes an operation of the authorization device 100 corresponds to the authorization program.

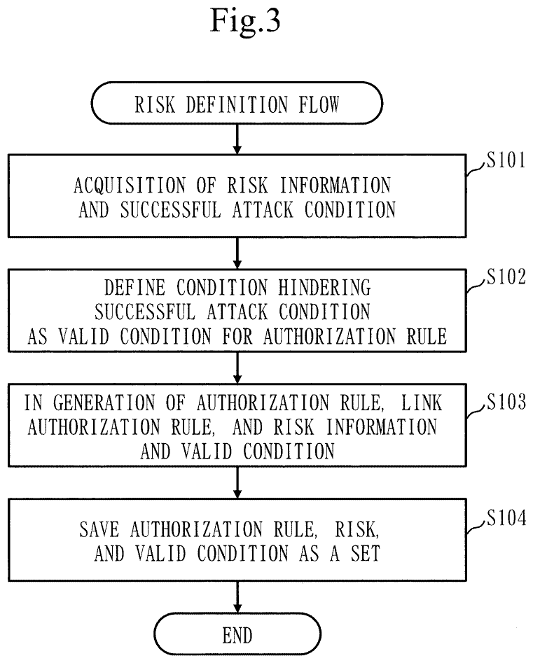

FIG. 3 is a flowchart illustrating an example of a risk definition flow. The risk definition flow is a process that generates the risk definition data 161. FIG. 3 is used to describe the risk definition flow.

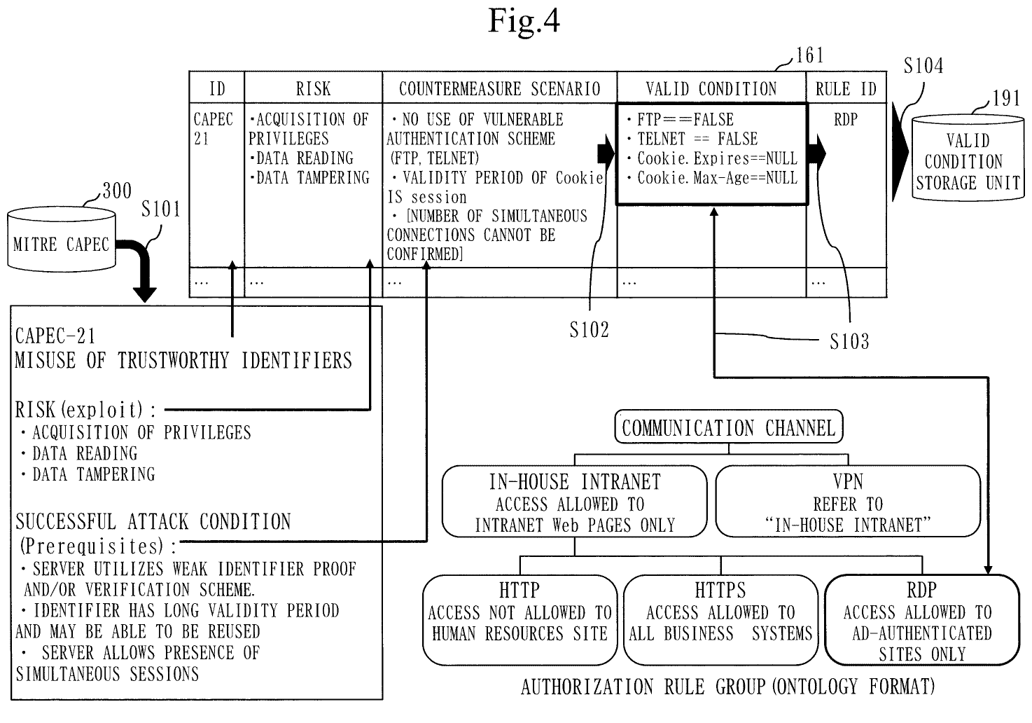

Also, FIG. 4 is a diagram that describes the risk definition flow. Below, specific examples of steps of the flowchart shown in FIG. 3 will be described with using FIG. 4. Note that in FIG. 4, the risk/vulnerability DB 300 is assumed to be MITRE CAPEC.

### (Step S101)

The risk definition data generation unit 160 acquires risk information and information indicating the successful attack condition from the risk/vulnerability DB 300.

As a specific example, the risk definition data generation unit 160 acquires the attack pattern of “Exploitation of Trusted Identifiers” defined under “CAPEC-21” from MITRE CAPEC. The risk corresponds to the item “exploit” of CAPEC-21. The successful attack condition corresponds to the term “Prerequisites” of CAPEC-21.

Note that the process of this step may be conducted by the administrator when linking the risk definition data 161 and the authorization rule in step S103.

### (Step S102)

The risk definition data generation unit 160 defines a condition that hinders the successful attack condition as a valid condition.

As a specific example, the risk definition data generation unit 160 shapes two of the risk and the successful attack condition into the risk definition data 161 as illustrated in FIG. 4. At this point, the risk definition data generation unit 160 determines the format of the “valid condition” as “(Attribute)=(Value)” so that the authorization device 100 can assess the “valid condition”. Here the “valid condition” is a condition generated by the administrator or the like on the basis of the “countermeasure scenario”.

### (Step S103)

In generation of the authorization rule, each generated authorization rule, and the risk and the valid condition are linked with each other. The administrator or the like carries out this linking process.

For example, if an authorization rule group consisting of multiple authorization rules is managed in an ontology format in the authorization device 100, a risk and a valid condition indicated by the risk definition data 161 are linked to a node corresponding to each authorization rule. Information indicating identifiers of nodes linked to the risks and the valid conditions are stored under “Rule ID” of the risk definition data 161. In FIG. 4, rules for the communication methods are indicated in the ontology format as the authorization rules. When the user uses RDP (Remote Desktop Protocol) in the in-house intranet, if a valid condition for RDP (rule ID) is met, the user can access the file server 400. There is a possibility that a user ID, which is weak in terms of security, of a user not participating in AD (Active Directory) might be hijacked by a brute force attack. On the other hand, a user participating in AD utilizes a strong-security user ID defined by the organization. This user ID can be verified. A valid condition for “RDP” matches the nature of the user ID of the user participating in AD.

### (Step S104)

The risk definition data generation unit 160 saves the generated risk definition data 161 to the valid condition storage unit 191.

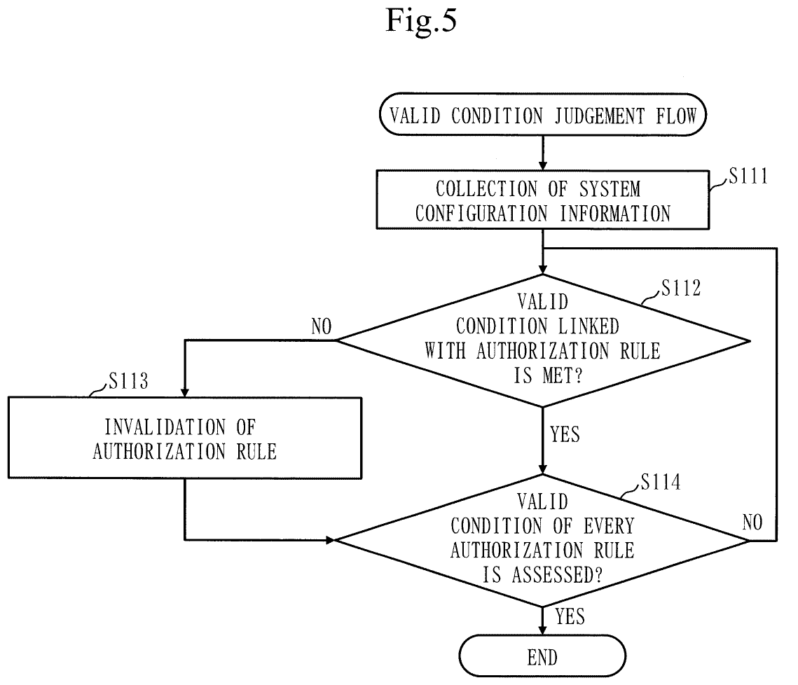

FIG. 5 is a flowchart illustrating an example of a valid condition judgment flow. The valid condition judgment flow is a process that judges whether or not a valid condition is met in the authorization of a user related to access to the file server 400. FIG. 5 will be used to describe the valid condition judgment flow.

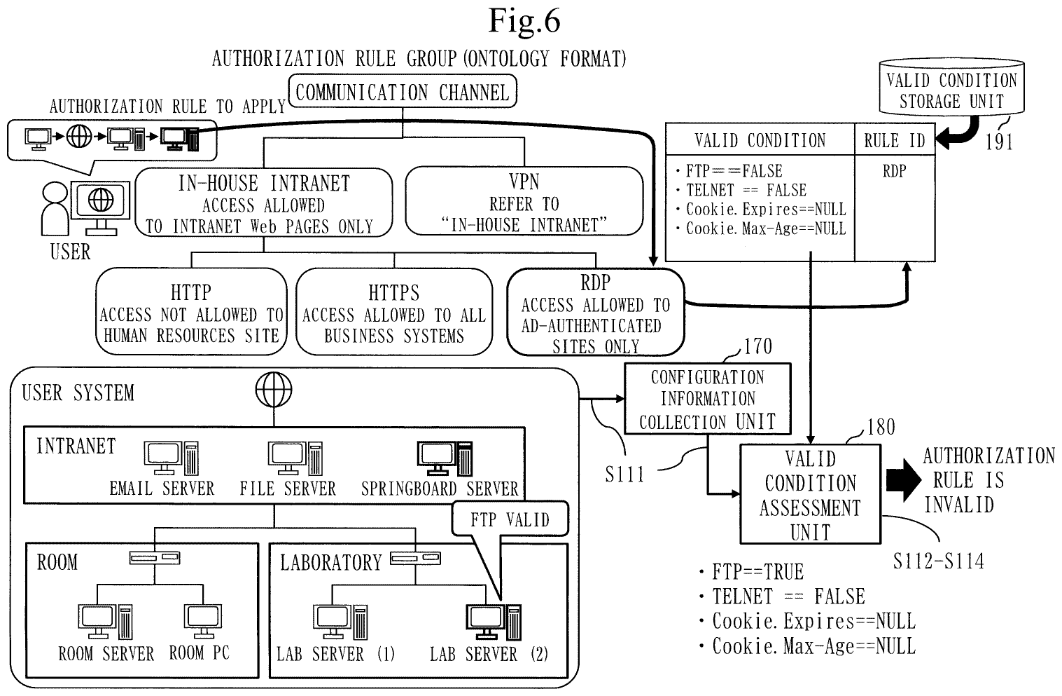

Also, FIG. 6 is a diagram describing the valid condition judgment flow. Hereafter, specific examples of the steps in the flowchart shown in FIG. 5 will be described using FIG. 6.

### (Step S111)

The configuration information collection unit 170 collects the configuration information 91 as context information that serves up to the file server 400 which the user accesses, and inputs the collected configuration information 91 into the valid condition assessment unit 180.

In the case where the user system is a control system, a method of collecting the configuration information 91, for example, involves utilizing ta technique related to an asset management & monitoring solution such as Nozomi Networks Guardian. However, any method may be used to collect the configuration information 91.

### (Step S112)

Firstly, the valid condition assessment unit 180 acquires a valid condition for an authorization rule (in FIG. 6, the rule corresponding to “RDP”) selected according to user access, from the valid condition storage unit 191. In FIG. 6, a rule ID of the selected authorization rule is stored under “Rule ID”.

Next, the valid condition assessment unit 180 judges whether the selected authorization rule is valid, based on the inputted configuration information 91 and the acquired valid condition. The valid condition may be assessed when the authorization rule is assessed in response to user access, or may be assessed regularly by a timer process or the like. The valid condition assessment unit 180 assesses the valid condition by comparing information (which is assumed to have been shaped to have the format “(Attribute)=(Value)”) indicated by the inputted configuration information 91 with “(Attribute)=(Value)” indicated by the acquired valid condition. If the information indicated by the inputted configuration information 91 satisfies all condition formulae indicated by the acquired valid condition, the acquired valid condition is met.

When the acquired valid condition is met with respect to the inputted configuration information 91, the valid condition assessment unit 180 concludes that the authorization rule for this valid condition is valid, and proceeds to step S114. Otherwise, the valid condition assessment unit 180 proceeds to step S113.

### (Step S113)

The valid condition assessment unit 180 invalidates the selected authorization rule. As a specific example, the valid condition assessment unit 180 sets the selected authorization rule as corresponding to “Access Denial”, or deletes the selected authorization rule itself.

In FIG. 6, the valid condition assessment unit 180 judges that a valid condition for RDP is not met because the value of FTP (File Transfer Protocol) is TRUE, and invalidates the authorization rule corresponding to RDP.

### (Step S114)

If there are multiple authorization rules to be assessed based on the user access, the same process is repeated.

### Explanation of the Effects of Embodiment 1

According to this Embodiment, the content of the risk is linked with the valid condition for the authorization rule in the risk definition data 161. Here, the content of the risk may be updated. Therefore, according to this Embodiment, the administrator or the like of the authorization rule, by referring to the content of the risk, can detect a case or the like where an authorization rule that has been set once loses its validity or needs improvement due to changes in the system environment. As a result, the reliability of the authorization rule improves according to this Embodiment. Changes in the system environment, for example, may include dismissal or the like of a security committee making the system administrator unnecessary, introduction or removal of standard regulations, or the improvement of the computer's processing capacity which results in a secure password length changing from 8 to 12 characters.

Furthermore, according to this Embodiment, the administrator or the like of the authorization rule can implement measures such as improving the system environment to match the valid condition and adding to the authorization rule a valid condition linked with the authorization rule.

An effect achieved when the authorization device 100 regularly refers to the external risk/vulnerability DB 300 such as CAPEC, and carries out the maintenance of the authorization rule, will be described. Since rules that are implicitly regarded as “a matter of course” need not be described in the authorization rule, setting of the authorization rule can be simplified. By acquiring data indicating the risk and data indicating a condition for allowance from the risk/vulnerability DB 300 or the like, the authorization rule can automatically follow the security level generally required in the world.

### ***Other Configurations***

### Modification 1

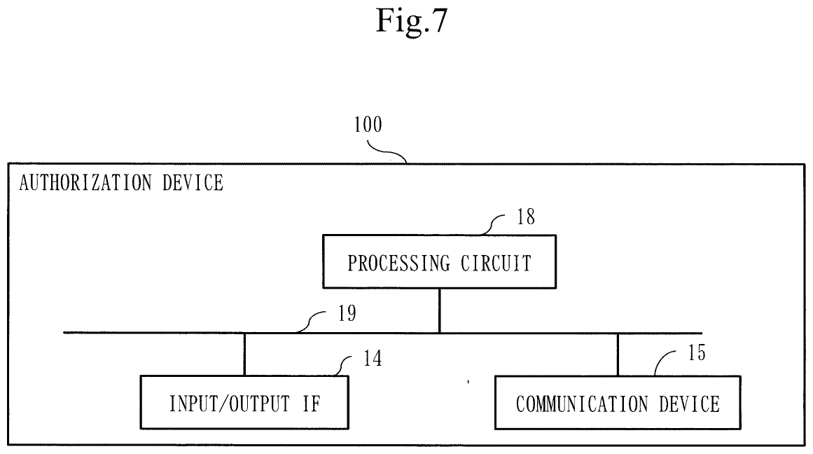

FIG. 7 illustrates a hardware configuration example for an authorization device 100 according to this modification.

The authorization device 100 is equipped with a processing circuit 18 instead of a processor 11; a processor 11 and a memory unit 12; a processor 11 and an auxiliary storage device 13; or a processor 11, a memory unit 12, and an auxiliary storage device 13.

The processing circuit 18 is hardware that realizes at least part of the components provided to the authorization device 100.

The processing circuit 18 may be dedicated hardware, or may be a processor that executes a program stored in the memory unit 12.

When the processing circuit 18 is dedicated hardware, for instance, the processing circuit 18 is a single circuit, a composite circuit, a programmed processor, a parallel programmed processor, an ASIC (Application Specific Integrated Circuit), an FPGA (Field Programmable Gate Array), or a combination of these.

As an alternative to the processing circuit 18, the authorization device 100 may include a plurality of processing circuits. The multiple processing circuits can share a role of the processing circuit 18.

In the authorization device 100, some functions may be implemented by dedicated hardware, while the remaining functions may be implemented by software or firmware.

The processing circuit 18 is implemented, in a specific example, by hardware, software, firmware, or a combination of these.

The processor 11, the memory unit 12, the auxiliary storage device 13, and the processing circuit 18 are collectively referred to as “processing circuitry”. Namely, the functions of the function constituent elements of the authorization device 100 are implemented by processing circuitry.

An authorization device 100 according to another embodiment may have the same configuration as that of this modification.

### Embodiment 2

Below, the aspects that differ from the previously mentioned Embodiment will mainly be described with reference to the drawings.

### ***Description of Configuration***

A configuration of an authorization system 90 according to this Embodiment is the same as the configuration of the authorization system 90 according to Embodiment 1. In this Embodiment, even when a valid condition for a certain authorization rule is not met, if an offsetting condition that offsets the valid condition is set for the certain authorization rule and the offsetting condition is met, the certain authorization rule will not be invalidated. The offsetting condition is a condition against the valid condition and required to exceptionally consider an authorization rule for the valid condition as valid when the valid condition is not met. The offsetting condition is a condition that applies to a case where there is no or very low security risk.

Risk definition data 161 according to this Embodiment includes an “offsetting condition”.

A risk definition data generation unit 160 according to this Embodiment appropriately sets the “offsetting condition” when generating the risk definition data 161 in practicing a risk definition flow. Note that there might be an authorization rule against which there is no “offsetting condition” exists.

A valid condition assessment unit 180 according to this Embodiment judges that an authorization rule is valid when a valid condition is not met and an offsetting condition against the valid condition is met. Specifically, in practicing a valid condition judgment flow, when an offsetting condition against a valid condition is set, even in a case where the valid condition assessment unit 180 judges that the valid condition is not met, if the offsetting condition is met, the valid condition assessment unit 180 does not invalidate an authorization rule for the valid condition.

### ***Description of Operation***

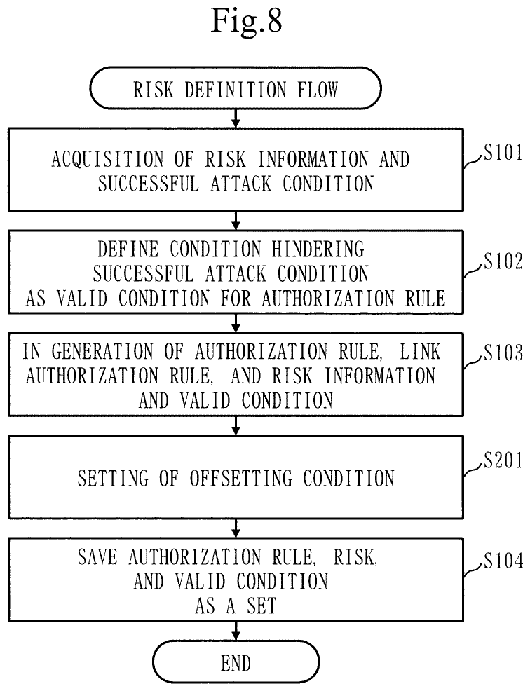

FIG. 8 is a flowchart showing an example of the risk definition flow according to this Embodiment. FIG. 8 is used to describe the risk definition flow.

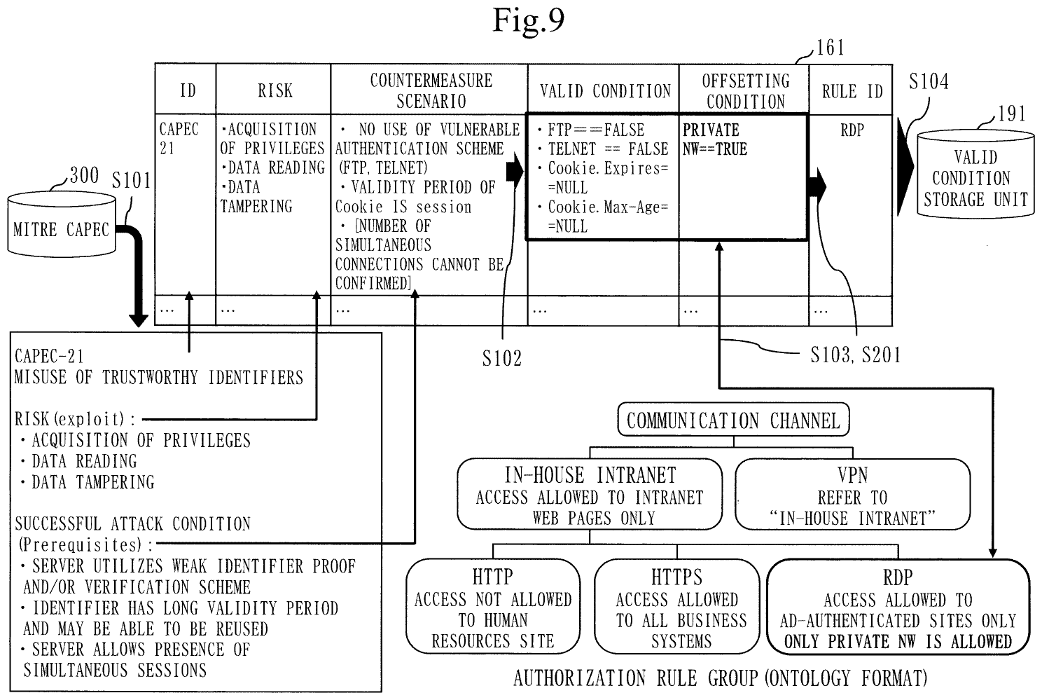

FIG. 9 is a diagram that describes the risk definition flow. Hereinafter, specific examples of the steps of the flowchart shown in FIG. 8 are described with using FIG. 9.

### (Step S201)

The risk definition data generation unit 160 sets the “offsetting condition” of the risk definition data 161. The “offsetting condition” may be set by an administrator or the like of the authorization rule.

In a specific example, the risk definition data generation unit 160 sets, as the offsetting condition, a condition that authorizes access to a file server 400 in a case where a user tries to access the file server 400 from a private network. Assume that when access is made from the private network to the file server 400, no security risk occurs.

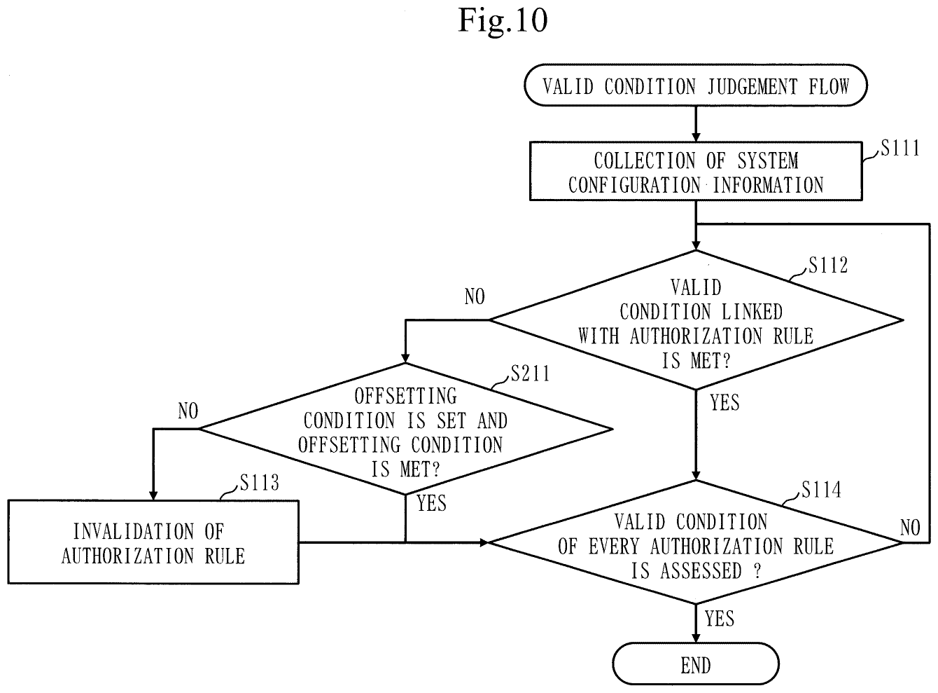

FIG. 10 is a flowchart illustrating an example of the valid condition judgment flow according to this Embodiment. FIG. 10 is used to describe the valid condition judgment flow.

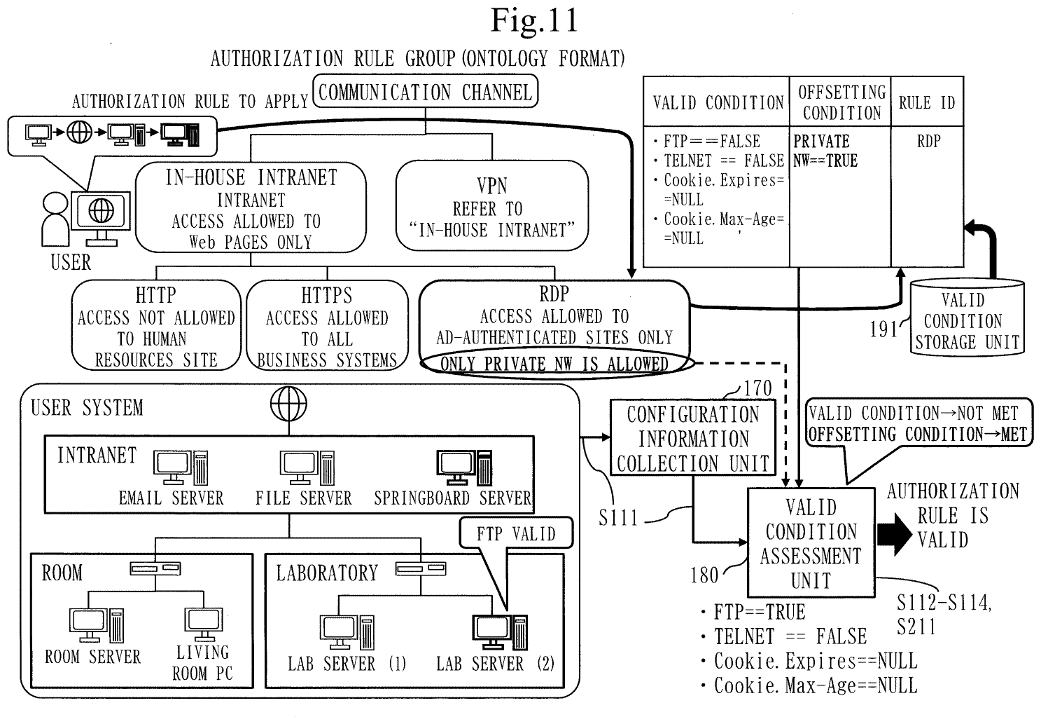

FIG. 11 is a diagram used to describe the valid condition judgment flow. Hereinafter, the specific examples of the steps in the flowchart shown in FIG. 10 will be described with using FIG. 11.

### (Step S112)

If an offsetting condition against a selected authorization rule exists as well as a valid condition for the selected authorization rule, the valid condition assessment unit 180 acquires the offsetting condition from a valid condition storage unit 191. Also, the valid condition assessment unit 180 proceeds to step S211 instead of proceeding to step S113.

The other processes are the same as those in step S112 according to Embodiment 1.

### (Step S211)

the offsetting condition against the selected authorization rule exists, the valid condition assessment unit 180 assesses whether the offsetting condition being set is met.

When the offsetting condition against the selected authorization rule is set and the offsetting condition being set is met, the valid condition assessment unit 180 proceeds to step S114. Otherwise, the valid condition assessment unit 180 proceeds to step S113.

In FIG. 11, the valid condition assessment unit 180 assesses whether the network being used by the user is a private network, and proceeds to step S114 on the grounds that the network being used by the user is a private network.

### Explanation of the Effects of Embodiment 2

According to this Embodiment, the offsetting condition is set by taking into account the security risk that does not occur under a particular circumstance. Therefore, it is possible to enhance the availability of the data stored in the file server 400 while maintaining the safety of the file server 400.

### Other Embodiments

The aforementioned Embodiments can be arbitrarily combined; any constituent element of each Embodiment can be modified; and any constituent element in each Embodiment can be omitted.

Embodiments are not limited to those shown in Embodiments 1 and 2, and various changes can be made as necessary. The procedures described using flowcharts, etc., may be appropriately modified.

### REFERENCE SIGNS LIST

11: processor; 12: memory unit; 13: auxiliary storage device; 14: input/output IF; 15: communication device; 18: processing circuit; 19: signal line; 90: authorization system; 91: configuration information; 100: authorization device; 110: ontology generation unit; 120: access request receiving unit; 130: policy candidate extraction unit; 140: access policy decision unit; 150: fitness judgment unit; 160: risk definition data generation unit; 161: risk definition data; 170: configuration information collection unit; 180: valid condition assessment unit; 190: ontology storage unit; 191: valid condition storage unit; 200: authentication server; 300: risk/vulnerability DB; 400: file server.

1. An authorization device comprising
processing circuitry
to assess whether a valid condition is met so as to judge whether an authorization rule is valid, the valid condition being a condition which is generated on a basis of a countermeasure scenario to address vulnerabilities related to access to a target system storing an electronic file, and which concerns an authorization target requiring authorization of access to the target system, the authorization rule being a rule for the valid condition and authorizing access to the target system.

2. The authorization device according to claim 1, wherein the processing circuitry assesses whether the valid condition is met on a basis of configuration information indicating a configuration of the authorization target.

3. The authorization device according to claim 1, wherein the target system is a system that adopts a zero trust model.

4. The authorization device according to claim 2, wherein the target system is a system that adopts a zero trust model.

5. The authorization device according to claim 1,
wherein the processing circuitry stores risk definition data that correlates data indicating the valid condition and data indicating a content of a risk to the valid condition.

6. The authorization device according to claim 2,
wherein the processing circuitry stores risk definition data that correlates data indicating the valid condition and data indicating a content of a risk to the valid condition.

7. The authorization device according to claim 3,
wherein the processing circuitry stores risk definition data that correlates data indicating the valid condition and data indicating a content of a risk to the valid condition.

8. The authorization device according to claim 4,
wherein the processing circuitry stores risk definition data that correlates data indicating the valid condition and data indicating a content of a risk to the valid condition.

9. The authorization device according to claim 1,
wherein the processing circuitry judges that the authorization rule is valid when the valid condition is not met and an offsetting condition against the valid condition is met.

10. The authorization device according to claim 2,
wherein the processing circuitry judges that the authorization rule is valid when the valid condition is not met and an offsetting condition against the valid condition is met.

11. The authorization device according to claim 3,
wherein the processing circuitry judges that the authorization rule is valid when the valid condition is not met and an offsetting condition against the valid condition is met.

12. The authorization device according to claim 4,
wherein the processing circuitry judges that the authorization rule is valid when the valid condition is not met and an offsetting condition against the valid condition is met.

13. The authorization device according to claim 5,
wherein the processing circuitry judges that the authorization rule is valid when the valid condition is not met and an offsetting condition against the valid condition is met.

14. The authorization device according to claim 6,
wherein the processing circuitry judges that the authorization rule is valid when the valid condition is not met and an offsetting condition against the valid condition is met.

15. The authorization device according to claim 7,
wherein the processing circuitry judges that the authorization rule is valid when the valid condition is not met and an offsetting condition against the valid condition is met.

16. The authorization device according to claim 8,
wherein the processing circuitry judges that the authorization rule is valid when the valid condition is not met and an offsetting condition against the valid condition is met.

17. An authorization method including
assessing whether a valid condition is met so as to judge whether an authorization rule is valid, the valid condition being a condition which is generated on a basis of a countermeasure scenario to address vulnerabilities related to access to a target system storing an electronic file, and which concerns an authorization target requiring authorization of access to the target system, the authorization rule being a rule for the valid condition and authorizing access to the target system.

18. A non-transitory computer readable medium recorded with an authorization program which causes an authorization device, being a computer, to execute
a valid condition assessment process of assessing whether a valid condition is met so as to judge whether an authorization rule is valid, the valid condition being a condition which is generated on a basis of a countermeasure scenario to address vulnerabilities related to access to a target system storing an electronic file, and which concerns an authorization target requiring authorization of access to the target system, the authorization rule being a rule for the valid condition and authorizing access to the target system.
